(19) United States
(12) Patent Application Publication
(10) Pub. No.: US 2008/0104514 A1
(43) Pub. Date: May 1, 2008

(54) METHOD AND APPARATUS FOR CONTROLLING REPRODUCTION OF AUDIO/VISUAL DATA

(75) Inventors: Man-seok KANG, Suwon-si (KR); Sung-wook Park, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/928,350

(22) Filed: Oct. 30, 2007

(30) Foreign Application Priority Data
Nov. 1, 2006 (KR) 2006-107472

(51) Int. Cl. G06F 3/00

(52) U.S. Cl. 715/719

(57) ABSTRACT

A reproduction apparatus and a method for controlling the reproduction of the audio/visual data in the apparatus includes: providing at least one input element selectable by a user to execute a predetermined function on a reproduction control screen so that the user controls the reproduction of the audio/visual data; and when the input element is selected by the reproduction apparatus, determining whether the input element is available with respect to information about the input element, and selecting the input element if the input element is available. Accordingly, a user can stably perform menu navigation regardless of conditions.

### CROSS-REFERENCE TO RELATED APPLICATION

This application claims the benefit of Korean Patent Application No. 2006-107472, filed on Nov. 1, 2006 in the Korean Intellectual Property Office, the disclosure of which is incorporated herein by reference.

### BACKGROUND OF THE INVENTION

1. Field of the Invention

An aspect of the present invention relates to a method and an apparatus for controlling reproduction of audio/visual data.

2. Description of the Related Art

In an information storage medium storing image data and menu data, various menus, such as a menu which includes a plurality of pages, a menu which appears or disappears according to a user's request, etc., can be configured. Since a reproduction apparatus for reproducing such an information storage medium must perform various menu navigation functions according to a user's request, the reproduction apparatus requires a method of allowing the user to manipulate buttons on a menu and execute commands by using the buttons.

FIG. 1A illustrates a screen in which a menu 100 including a plurality of buttons is displayed, according to a conventional technique. Referring to FIG. 1A, the menu 100 includes a button 1 110, a button 2 120, a button 3 130, a button 4 140, a button 5 150, a button 6 160, and a button 7 170. The buttons 2 120, the button 4 140, and the button 6 160, which are denoted by oblique lines, perform predetermined commands when they are selected, and the remaining buttons 1 110, 3 130, 5, 150, and 7 170 are background images of the menu 100. However, the buttons 1 110, 3 130, 5, 150, and 7 170 include button movement information and therefore are not selected during menu navigation, but they do not include command information.

FIG. 1B is a table showing button configuration information about the buttons 1 through 7 of the menu 100 illustrated in FIG. 1A.

Referring to FIG. 1B, the button configuration information includes button identifiers (IDs) for identifying the respective buttons 1 through 7, up-down-right-left movement information which is button movement information 180 indicating a next button that is to be selected when a direction key is pressed by a user while a button is selected, and information indicating whether or not commands are included in the respective buttons 1 through 7.

Referring to FIGS. 1A and 1B, in regard to button movement information of the button 2 120 whose button ID is 2, while the button 2 is in a selected status, the button 6 is selected if the user presses a left direction key, and the button 4 is selected if the user presses a right direction key. If the user inputs an up or down direction key while the button 2 is in the selected status, the button 2 is maintained as it is. Also, while the button 4 is in a selected status, the button 2 is selected if the user presses the left direction key, the button 6 is selected if the user presses the right direction key, and the button 4 is maintained as it is if the user presses the up or down direction key. Also, while the button 6 is in the selected status, the button 4 is selected if the user presses the left direction key, the button 2 is selected if the user presses the right direction key, and the button 6 is maintained as it is if the user presses the up or down direction key. The button movement information of the remaining buttons 1, 3, 5, and 7 are similarly described in FIG. 1B. Since the buttons 2, 4, and 6 have no button movement information for moving to the buttons 1, 3, 5, and 7, the buttons 1, 3, 5, and 7 are not selected during button conversion. If the button 1, 3, 5, or 7 changes to a selected status due to a certain factor, any direction key input cannot convert the selection button 1, 3, 5, or 7 into a different button. Furthermore, since the button 1, 3, 5, or 7 includes no command, no operation is executed.

FIG. 2A is a view for explaining a method in which a menu changes between an activation status and an inactivation status. The menu includes a fixed type menu and a user request type menu. The fixed type menu is displayed on a screen at a designated time, and disappears from the screen and is erased from a buffer of a decoder at another designated time. The user request type menu appears on a screen only when a user issues an activation request by using an input device such as a remote control while menu information is maintained in a buffer of a decoder, and disappears from the screen when the user issues an inactivation request.

In the fixed type menu and the user request type menu, a status in which the menu is displayed on a screen is referred to as an activation status 30. A status in which the menu is not displayed on the screen is referred to as an inactivation status 10. That is, in the case of the fixed type menu, until a designated time elapses after fixed type menu data is completely configured as menu configuration information in a decoder, the menu maintains the inactivation status 10.

When the designated time elapses, the menu changes to an activation state and is displayed on the screen. Then, the menu disappears from the screen at another designated time, and changes to the inactivation status 10 if the menu is erased from a buffer of the decoder. In the case of the user request type menu, until the user issues an activation request after the user request type menu data is completely configured as menu configuration information in the decoder, the menu maintains the inactivation status 10. When a user's activation request is issued, the menu is activated and displayed on the screen into the activation status 30. If the user issues an inactivation request or if an inactivation command is executed, the menu disappears from the screen and returns to the inactivation status 10.

Referring to FIG. 2A, when the menu is in the inactivation status 10, it is possible to change active page information and selection button information stored in a system register in a reproduction apparatus when a command is executed 40, regardless of conditions. However, when the menu is in the activation status 30, an active page conversion process 50 must be performed in order to correct the active page information. Also, when the menu is converted from the inactivation status 10 to the activation status 30, a menu status conversion process 20 is performed.

In the menu status conversion process 20, a selection button selecting process for activating a first page of menu configuration information and selecting an initial selection button is performed. In the active page conversion process 50, it is determined whether a number of a page which is designated to an activation status is valid on current menu configuration information. If the page number is valid, the designated page is activated and the selection button selecting process is performed. If the page number is not valid, no page conversion is performed. In this case, if a button number apart from the page number is designated as a command factor in a command “Set Button Page( )” for page conversion in an activation status, the designated button number is designated a selected status, instead of performing the selection button selecting process.

FIG. 2B is a flowchart illustrating the selection button selecting process described above with reference to FIG. 2A. In order to determine a button that is to be selected, default_selected_button_id information included in a page which will be activated and selection button information stored in a system register of the reproduction apparatus are obtained (operation 210).

If the default_selected_button_id information indicates a number of a valid button which can be designated a selected status, from among buttons included in the page that is to be activated (operation 220), the corresponding button is designated a selected status and the selection button information of the system register is updated according to the corresponding button (operation 230).

However, if the default_selected_button_id information indicates that no valid button exists, it is determined whether a button stored as selection button information in the system register is a valid button which can be designated to a selected status among the buttons included in the page that is to be activated (operation 240). If the button is a valid button which can be designated to a selected status, the corresponding button is designated a selected status (operation 250).

If the button is not a valid button which can be designated a selected status, it is determined whether a valid button which can be designated a selected status exists among the buttons included in the page that is to be activated (operation 260). If a valid button which can be designated a selected status exists in the page that is to be activated, the button is designated a selected status. If a plurality of valid buttons which can be designated a selected status exist in the page that is to be activated, a first button from among the valid buttons is designated a selected status (operation 270), and the selection button information of the system register is updated. However, if there are no valid button which can be designated an activation status, all the buttons are in a non-selected status and the selection button information of the system register is initialized (operation 280).

In FIG. 2B, when the operation 250 or 270 is performed, a background image button or a hidden button, instead of a button for menu navigation, can acquire a selected status. If the background image button or the hidden button changes to the selected status, a problem occurs in that a user cannot recognize which button is in a selected status and can perform neither button conversion nor command execution.

This problem can also occur when page conversion is performed while the menu is activated. A command “Set Button Page( )” for page conversion can designate an activated page number and a selection button number. However, when a selection button is changed in a page which is currently in an activation status 30, a page number cannot be designated. Also, when a page is converted into a different page, a button number that is to be selected cannot be designated. As such, if a button number that is to be selected is not designated when the command “Set Button Page( )” is executed, the selection button selecting process is performed when a page which is in an activation status 30 is converted into a different page, and an improper button may be selected when the selection button selecting process is performed.

### SUMMARY OF THE INVENTION

An aspect of the present invention provides a method and apparatus for controlling reproduction of audio/visual data, capable of stably performing menu navigation.

According to an aspect of the present invention, there is provided a method for controlling reproduction of audio/visual data in an apparatus for reproducing the audio/visual data, the method including: providing at least one input element selectable by a user to execute a predetermined function on a reproduction control screen so that the user controls the reproduction of the audio/visual data; and when the input element is selected by the reproduction apparatus, determining whether the input element is available with reference to information about the input element, and selecting the input element if the input element is available.

According to an aspect of the present invention, the information about the input element includes at least one of movement information of the input element, command information of the input element, and image information of the input element.

According to an aspect of the present invention, the selecting of the input element includes: determining at least one of whether the movement information of the input element indicates a different input element, whether the command information of the input element exists, and whether the image information of the input element exists; and if it is determined that the movement information of the input element indicates the different input element, that the command information of the input element exists, or that the image information of the input element exists, determining that the input element is available.

According to an aspect of the present invention, the selecting of the input element includes assigning priorities to at least one piece of information included in the information about the input element, and selecting an input element having a highest priority.

According to an aspect of the present invention, the selecting of the input element includes: determining whether an input element initially designated in an active page is available with reference to information about the initially designated input element; and if it is determined that the initially designated input element is available, selecting the initially designated input element.

According to an aspect of the present invention, the selecting of the input element includes: if it is determined that the initially designated input element is not available, determining whether the different input element is available with reference to information about the different input element; and if it is determined that the different input element is available, selecting the different input element.

According to an aspect of the present invention, the selecting of the input element further includes, if it is determined that all input elements in the active page are not available, selecting the initially selected input element.

According to an aspect of the present invention, the input element is selected by the reproduction apparatus, when a status of the reproduction control screen is converted or when a page of the reproduction control screen is converted.

According to an aspect of the present invention, the reproduction control screen includes a menu, and the input element includes a button included in the menu.

According to another aspect of the present invention, there is provided an apparatus for controlling reproduction of audio/visual data, in an apparatus for reproducing the audio/visual data, including: a reproduction controller providing at least one input element selectable by a user to execute a predetermined function on a reproduction control screen so that the user controls the reproduction of the audio/visual data, wherein the reproduction controller includes a controller determining whether the input element is available with reference to information about the input element when the input element is selected by the reproduction apparatus, and selecting the input element if the input element is available.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1A illustrates a screen in which a menu including a plurality of buttons is displayed, according to a conventional technique;

FIG. 1B is a table showing button configuration information about the buttons of the menu illustrated in FIG. 1A;

FIG. 2A is a view for explaining a method in which a menu changes between an activation status and an inactivation status;

FIG. 2B is a flowchart illustrating a selection button selecting process included in the method illustrated in FIG. 2A;

FIG. 3 is a block diagram of a reproduction apparatus according to an embodiment of the present invention;

FIG. 4 illustrates an exemplary structure of a stream which the reproduction apparatus, according to an embodiment of the present invention, reads from a recording medium;

FIG. 5 is a flowchart illustrating a method of selecting an appropriate button, according to an embodiment of the present invention;

FIG. 6A illustrates a menu screen of a first page from among two pages that are to be displayed, in the method of selecting the appropriate button according to the embodiment of the present invention;

FIG. 6B illustrates a detailed menu configuration of the menu screen illustrated in FIG. 6A;

FIG. 6C is a table showing button configuration information of buttons illustrated in FIG. 6B;

FIG. 7A illustrates a menu screen of a second page from among the two pages that are to be displayed, in the method of selecting the appropriate button according to the embodiment of the present invention;

FIG. 7B illustrates a detailed menu configuration of the menu screen illustrated in FIG. 7A; and

FIG. 7C is a table showing button configuration information of buttons illustrated in FIG. 7B.

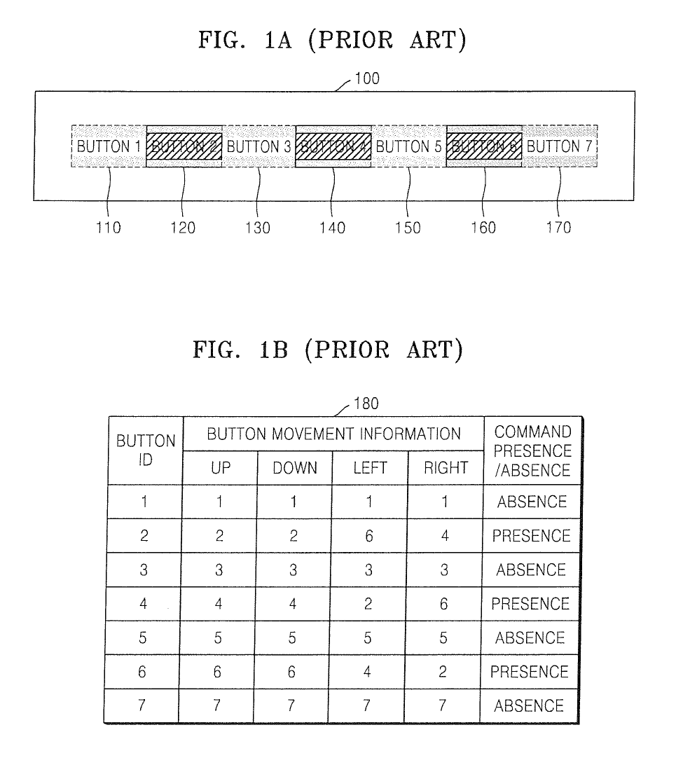

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

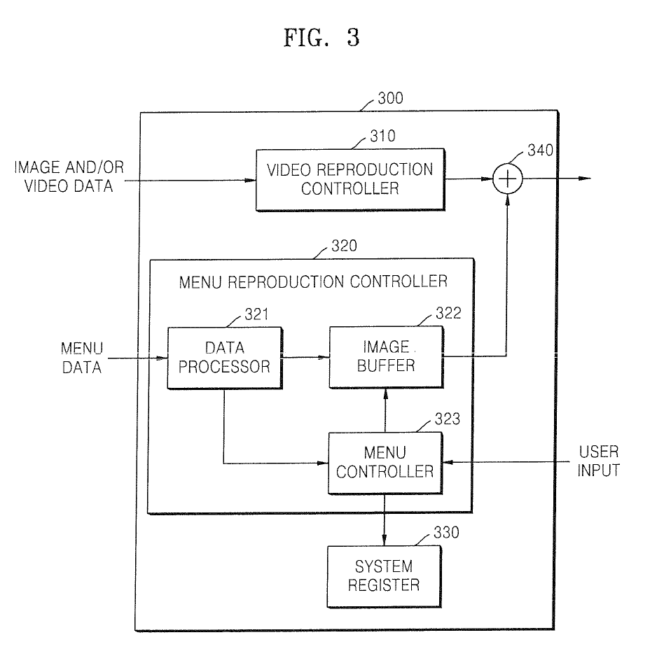

A reproduction apparatus, such as the reproduction apparatus 300 of FIG. 3, provides reproduced images to users, using an information storage medium which stores image reproduction information. The reproduction apparatus selects a stream that is to be reproduced from the information storage medium, divides the selected stream into video data, audio data, menu data, and other data, transmits the respective data to the corresponding decoders, respectively, and outputs images, sounds, menus, subtitles, etc. using a reproduction controller. The reproduction apparatus automatically reproduces images based on navigation data stored in the information storage medium. At this time, simple reproduction control functions, such as title movement, chapter movement, etc., can be provided by a system menu provided by the reproduction apparatus, and various reproduction control functions can be provided by a user menu provided by the reproduction apparatus on the basis of menu data provided by the information storage medium. While not required in all aspects, the apparatus can further record data to an information storage medium, and/or can be a stand alone apparatus and/or implemented in a computer.

The functions that can be provided by the menu data include title movement, chapter movement, audio/subtitle language selection, etc. In this specification, the term “menu” refers generally to an exemplary reproduction control screen allowing a user to control reproduction of the audio/visual data. Accordingly, the term “menu” will be mainly used, however, the present invention is not limited to this. That is, the menu includes an arbitrary reproduction control screen allowing a user to control reproduction of audio/visual data. However, it is understood that the menu can also be used to reproduce other data, such as programs, and can be used to access and/or reproduce other audio/video data not read from the information storage medium such as data obtained across a network.

Also, the term “button” generally refers to an input element which is displayed on the reproduction control screen and can be selected by the user, in order to execute a predetermined function. Accordingly, the term “button” will be mainly used, however, the present invention is not limited to this. That is, the button includes an arbitrary input element which is displayed on a reproduction control screen and can be selected by a user, in order to execute a predetermined function. Other examples of input elements can include dials, switches, slides in addition to or instead of buttons.

FIG. 3 is a block diagram of a reproduction apparatus 300 according to an embodiment of the present invention. Referring to FIG. 3, the reproduction apparatus 300 includes an image or video reproduction controller 310, a menu reproduction controller 320, a system register 330, and a coupler 340. The menu reproduction controller 320 functions as a controller for controlling menu reproduction. The output of the coupler 340 is displayed on a screen (not shown) and/or output through speakers (not shown).

When the reproduction apparatus 300 reads a stream that is to be reproduced from a storage medium (not shown), image data from the stream is transferred to the image reproduction controller 310. Menu data from the stream is transferred to the menu reproduction controller 320. In this case, the reproduction apparatus 300 can download a stream that is to be reproduced through a network, or read a stream that is to be reproduced from an additional storage medium installed in the reproduction apparatus 300 using a pickup.

The menu data transferred to the menu reproduction controller 320 is decoded by a data processor 321. Image data in the menu data is stored in an image buffer 322 and menu configuration information and color information of the menu data are stored in a menu controller 323.

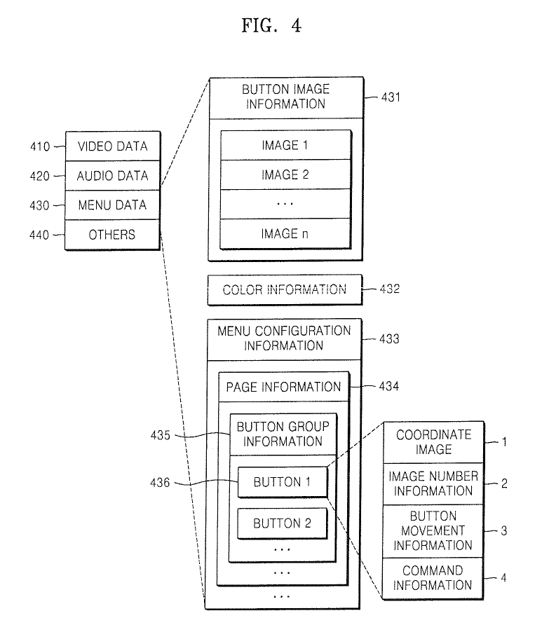

The structure of the stream read from the storage medium by the reproduction apparatus 300 will be described with reference to FIG. 4, below. Referring to FIG. 4, the stream that is to be reproduced includes video data 410, audio data 420, menu data 430, and other data 440 such as subtitle data, etc.

The menu data 430 is a menu which is provided from the storage medium in order to allow a user to control reproduction. The menu data 430 includes button image information 431 including image information about buttons that are to be displayed on a screen, color information 432 which are used when button images are displayed on the screen, and menu configuration information 433 including information about the functions and display form of the menu. However, the menu data 430 can include other data, such as audio data, in addition to or instead of the shown image and/or color data.

The menu configuration information 433 includes page information 434 which defines the configuration of buttons that are to be displayed on the screen at a certain time. The menu configuration information 433 can include no page or include one or more pages. When each page is activated and displayed on an initial screen, a button which is in a selected status must be designated. A manufacturer of the information storage medium can designate a specific button to a selected status using default_selected_button_id information. The default_selected_button_id information can indicate a button in a page. However, if the manufacturer does not designate a specific button, the reproduction apparatus can select a button among selectable buttons included in the page as a default.

Also, the page information 434 includes button group information 435 containing information about buttons displayed on the screen. A button group, which is defined in the button group information 435, may include one or more buttons. Only one of a plurality of buttons included in the button group can be available or no button in the button group can be available. When a button group including one or more buttons is displayed on an initial screen, an available button is designated according to the default_valid_button_id information. The term “available” means that the corresponding button can be selected by using user's menu navigation or by a navigation command.

Button information 436 included in the button group information 435 includes an image of the corresponding button. In more detail, the button information 436 of each button includes coordinate information 1 indicating a location of a button image that is to be displayed on a screen, image number information 2 indicating one of a plurality of images included in the button image information 431 or indicating that the corresponding image does not exist in the button image information 431, button movement information 3 indicating a button which is selected by a user when button conversion is performed in an up, down, left or right direction by the user, and command information 4 including navigation commands which are executed in order to activate buttons.

Hereinafter, the operation of the reproduction apparatus 300 will be described with reference to FIGS. 3 and 4. When decoded menu data 430 is output on a screen (not shown), the menu controller 323 activates a first page from the menu configuration information 433, configures buttons that are to be displayed on the screen from the button group information 435 included in the first page with reference to the default_valid_button_id information included in the first page, then designates a button which is to be selected with reference to the default_selected_button_id information and the selected button information stored in the system register 330, and outputs the resultant buttons on the screen (not shown).

Thereafter, the user can transfer an input to the reproduction apparatus 300, using an input device such as a remote controller or the keyboard of the apparatus 300. The user's input is transferred to the menu controller 323, and the menu controller 323 performs button conversion or button activation so that the corresponding navigation command is executed. At this time, when button conversion or page conversion is performed according to the user's input, active page information and selected button information are directly reflected to the system register 330.

Particularly, the menu reproduction controller 320 provides at least one button selectable by the user to execute a predetermined function, on a menu screen for allowing the user to control reproduction of audio/visual data. Also, when a button provided on the menu screen is selected by the reproduction apparatus, the menu controller 323 determines whether the button is available, with reference to information about the button, (that is, with reference to the image button information 431 or the button information 436 of the menu configuration information 433 illustrated in FIG. 4) and selects the button if the button is available.

The determination of whether the button is available depends on whether button movement information 3 for converting a selected button into a different button exists, whether command information 4 that is to be executed when the corresponding button is selected exists, whether image information 2 for the corresponding button exists, etc. The determination of whether the button is available can be performed in various ways in aspects of the invention. If all the conditions described above are satisfied (that is, if it is determined that button movement information for converting a selected button into a different button exists, that command information 4 that is to be executed when the corresponding button is selected exists, and that image information 2 for the corresponding button exists), it can be determined that the button is available. Also, if one of the above conditions is satisfied (that is, if it is determined that button movement information 3 for converting a selected button into a different button exists, that command information 4 that is to be executed when the corresponding button is selected exists, or that image information 2 for the corresponding button exists), it can be determined that the button is available. Also, by assigning priorities to the conditions, it can be determined that a button which satisfies a condition having a highest priority is available.

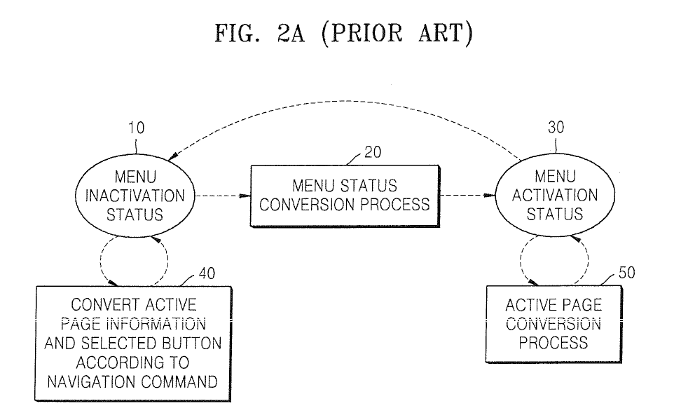

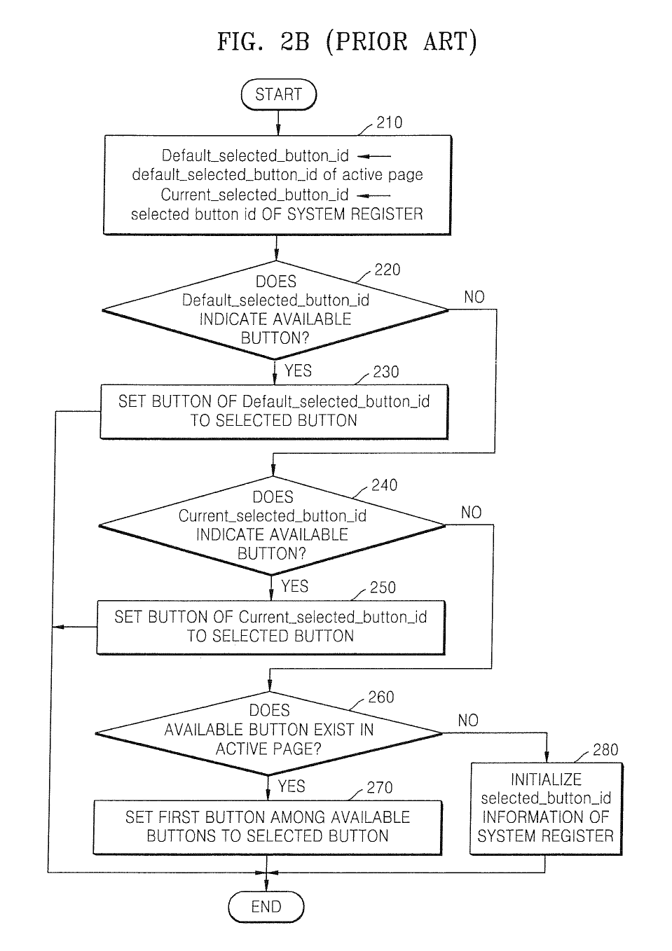

FIG. 5 is a flowchart illustrating a method of selecting an appropriate button, according to an embodiment of the present invention. The method illustrated in FIG. 5 is performed before operation 250 is performed in FIG. 2B. Further, the method illustrated in FIG. 5 is performed before operation 270 is performed in FIG. 2B.

Referring to FIG. 5, it is determined whether a button that is to be designated a selected status includes command information and whether button movement information indicates a different button (operation 510). However, conditions for selecting a button are not limited to the above two conditions, and an arbitrary condition of determining whether the button is available can be used. For example, a determination of whether a button image exists can be used. That is, a condition that a button is not selected if its button image information is set to a value indicating no image, can be set. In the case of a button having no button image information, since no button image that is to be displayed on a screen exists, a user cannot recognize the presence of the corresponding button. Accordingly, if the button is designated a selected status, the user will recognize that no button is selected.

If the above two conditions are satisfied, the designated different button is set to a selected status (operation 520). A condition for determining whether a button can be designated a selected status can be limited to a case where both the above-described conditions are satisfied, but it is understood that additional conditions can be imposed in other aspects. If no button satisfying both of the above-described conditions exists, by assigning priorities to the conditions, a button which satisfies a condition having a higher priority can be selected. Also, a button which satisfies one of the conditions can be designated a selected status.

If both conditions are not satisfied, it is determined whether a different available button exists in a current active page (operation 530). If a different available button exists in the current active page, the available button is selected (operation 550) and the process proceeds to operation 510. In operation 510, a determination of whether the two conditions are satisfied with respect to the available button is performed.

If no available button included in the current active page satisfies the two conditions, or if no different available button exists in the current active page, an initially selected button is designated a selected status (operation 540) and the process is terminated.

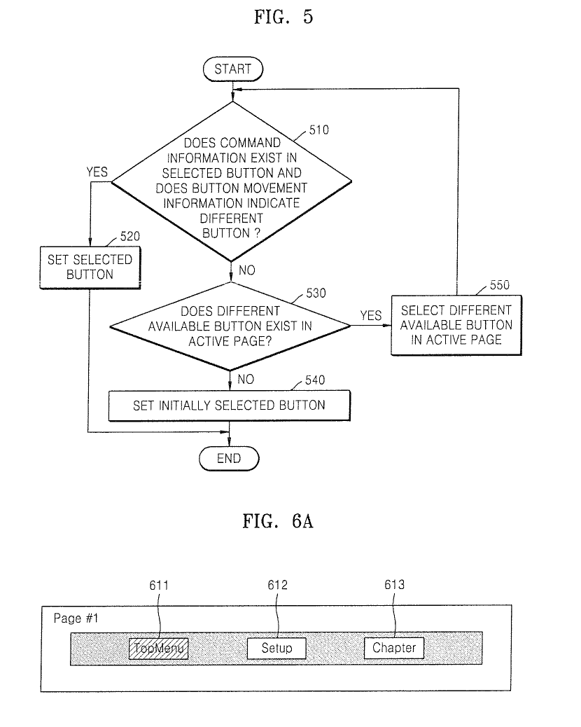

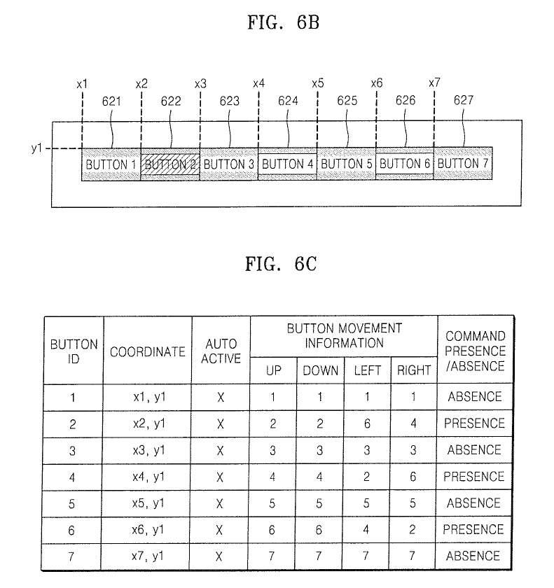

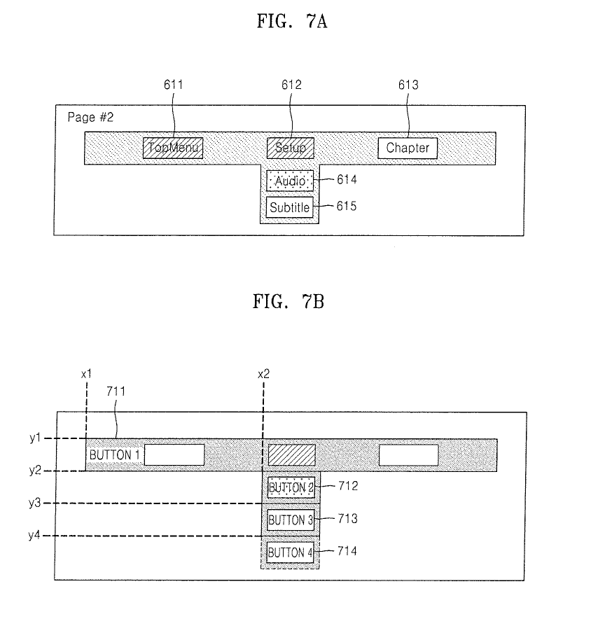

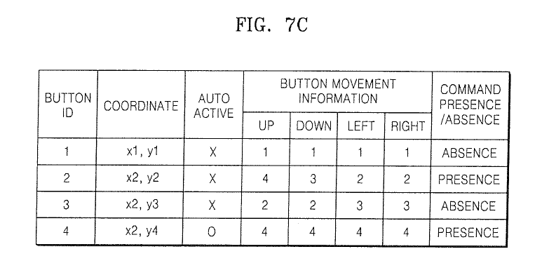

A detailed example in which a button is selected on a menu screen consisting of two pages will be described with reference to FIGS. 6A through 6C and 7A through 7C, below. FIG. 6A illustrates a menu screen of a first page from among the two pages, and FIG. 7A illustrates a menu screen of a second page from among the two pages.

Referring to FIG. 6A, a menu of the first page includes a “TopMenu” button 611 for moving to a TopMenu title, a “Setup” button 612 including a lower menu for selecting a language for subtitles and audio, and a “Chapter” button 613 including a lower menu for moving to a different chapter. Also, background images are included in the menu. FIG. 6B illustrates a detailed menu configuration of the menu screen illustrated in FIG. 6A.

Referring to FIGS. 6A and 6B, a button 2 622 representing the “TopMenu” button 611, a button 4 624 representing the “Setup” button 612, and a button 6 626 representing the “Chapter” button 613, are positioned at (x2, y1), (x4, y1), and (x6, y1), respectively. Also, a button 1 621, a button 3 623, a button 5 625, and a button 7 627 which are background images of the menu, are positioned at (x1, y1), (x3, y1), (x5, y1), and (x7, y1), respectively.

FIG. 6C is a table showing button configuration information of the buttons 1 through 7 illustrated in FIG. 6B. Referring to FIG. 6C, the button configuration information includes button IDs for identifying the respective buttons 1 through 7, coordinates for representing the output locations of the buttons 1 through 7, auto activation information indicating whether to automatically perform a command when each button becomes a selected status, up-down-left-right button movement information indicating which button changes to a selected status when a direction key is pressed by a user in the state that a button is selected, and the number of commands included in each button and information about the commands.

Referring to FIGS. 6A, 6B and 6C, command information of the button 2 622 representing the “TopMenu” button 611 includes a “Call Title(0)” command for moving to a TopMenu title, command information of the button 4 624 representing the “Setup” button 612 includes a “Set Button Page (page: 2, button:2)” command for moving to a second page for selecting a language for subtitles and audio, and command information of the button 6 626 representing the “Chapter” button 613 includes a “Set Button Page(page: i, button j)” command for moving to a page (for convenience of description, referred to as an i-th page) allowing chapter movement.

When the button 2 is selected, the button 6 is selected if the user presses a left direction key, and the button 4 is selected if the user presses a right direction key. Also, when the button 4 is selected, the button 2 is selected if the user presses the left direction key, and the button 6 is selected if the user presses the right direction key. When the button 6 is selected, the button 4 is selected if the user presses the left direction key, and the button 2 is selected if the user presses the right direction key. Since button movement information of the remaining buttons 1, 3, 5, and 7 indicates themselves and the buttons 2, 4 and 6 have no information for moving to the buttons 1, 3, 5, and 7, the buttons 1, 3, 5, and 7 will not be selected. If any one of the buttons 1, 3, 5, and 7 is selected, no direction key input can convert the selected button 1, 3, 5, or 7 into a different button. Furthermore, since the button 1, 3, 5, or 7 does not include any command, no operation is executed.

FIG. 7A illustrates a menu screen of a second page from among the two pages that are to be displayed, in the method of selecting the appropriate button according to an embodiment of the present invention. Referring to FIG. 7A, the lower menu of a “Setup” button 612 includes an “Audio” button 614 for moving to a lower menu for selecting a language for audio, and a “Subtitle” button 615 for moving to a lower menu for selecting a language for subtitles. The second page also constitutes a button. However, button movement information of the buttons is configured so that the buttons are not selected during the user's menu navigation. Also, the buttons include no command information.

FIG. 7B illustrates a detailed menu configuration of the menu screen illustrated in FIG. 7A. Referring to FIG. 7B, a button 2 712 representing an “Audio” button 614 and a button 3 713 representing a “Subtitle” button 615 are positioned at (x2, y2) and (x2, y3), respectively. Also, a button 1 711 for representing a menu screen of the second page is positioned at (x1, y1). A hidden button 4 714, which has no image and is not displayed on the screen, is positioned at (x2, y4).

FIG. 7C is a table showing button configuration information of the buttons illustrated in FIG. 7B. Referring to FIG. 7C, command information of the button 2 712 representing the “Audio” button includes a “Set Button Page (page: m, button: k)” button for moving to a lower menu (for convenience of description, referred to as a m-th page) for setting a language for “Audio”, and command information of the button 3 713 representing the “Subtitle” button includes a “Set Button Page (page: n, button: l)” button for moving to a lower menu (for convenience of description, referred to as a n-th page) for setting a language for subtitles. Also, the auto activation information of the hidden button 4 714 is set to “TRUE” so that the hidden button 4 714 is automatically activated when being selected to perform a command. The hidden button 4 714 includes a “Set Button Page (page: 1, button: 4)” button.

If the button 4 624 of the first page shown in FIG. 6B is activated and a command is executed, the second page is activated and the button 2 712 shown in FIG. 7B is selected. That is, the button 2 712 representing the “Audio” button is selected, and “page: 2, selected button: 2” is stored in the system register.

At this time, if the user presses a down direction key, the button 3 713 is selected. If the user presses an up direction key, the hidden button 4 714 is selected and simultaneously activated, and a command is executed, so that the first page shown in FIG. 6B is activated and the button 4 624 is selected.

Also, in the second page, if the user presses the up direction key or the down direction key when the button 3 713 representing the “Subtitle” button is in the selected status, the button 2 712 representing the “Audio” button is selected.

The remaining button 1 711 is a button including a background image for representing a screen of the first page. Button movement information of the button 1 711 indicates itself and includes no command information.

It is assumed that the menus illustrated in FIGS. 6A and 7A are user request type menus, default_selected_button_id information of a first page indicates that no available button exists, that is, default_selected_button_id information of a first page is set to a value indicating that no default selected button exists and therefore no button that is to be selected is defined when the first page is activated, without indicating a button ID of one from among available buttons included in the first page, the first page is activated, and a “TopMenu” button is selected when the menus are activated by a user's request. Thereafter, if the user presses the “Setup” button and then presses an enter key, a command of the “Setup” button 612 is executed so that the second page is activated, and the button 2 712 is selected. Then, if the user presses the down direction key, the button 3 713 is selected according to the button movement information of the button 2 712. At this time, active page information of the system register 330 is set to “2”, and selected button information of the system register 330 is set to “3”.

In this case, if the user issues a menu inactivation request, the menu disappears from the screen and an inactivation status is set. However, the active page information and selected button information of the system register 330 are maintained as they are.

If the user again issues a menu activation request, the first page is activated. In this case, since the default_selected_button_id information of the first page is set to a value indicating that no default selection button exists, it is determined whether a button having a button ID 3 from among buttons included in the first page is available according to the selected button information. In other words, if a specific page is activated, when default_selected_button_id information included in the corresponding page information indicates one of a plurality of buttons included in the page, the corresponding button is automatically selected. However if the default_selected_button id is set to a value indicating that no default_selected_button exists, a button in the first page corresponding to an ID value of a previously selected button is selected. In the above example, since the selection button information is set to “3”, a button corresponding to the button ID 3 of the first page is selected, and it is determined whether the button having the button ID 3 is available.

In this case, according to a conventional technique, since the selection button information of the system register 330 is “3” and the button 3 623 is available in the first page, the button 3 623 is set to a selected status. However, since all button movement information of the button 3 623 indicates itself and includes no command information, the user cannot perform menu navigation. However, according to an embodiment of the present invention, although a currently selected button ID is available, a button is finally selected by the process as illustrated in FIG. 5. That is, according to an aspect of the present invention, it is determined whether the selected button 3 623 includes command information, whether button movement information exists, etc. Considering information of the button 3 623 in the button configuration information illustrated in FIG. 6C, button movement information of the button 3 623 indicates itself and the information of the button 3 623 includes no command information. Accordingly, the button 3 623 is not set to a selection button. Thus, it is determined whether a different available button exists in the active page (that is, in the first page). Since the button configuration information illustrated in FIG. 6C indicates that the button 2, the button 4, and the button 6 are available buttons including button movement information and command information, one of the buttons 2, 4, and 6 can be selected.

As such, if a process of selecting a button that is to be designated a selected status is performed when menu status conversion or menu page conversion is performed, an improper button may be selected so that a user can perform neither conversion between buttons nor execution of a button command. In order to remove these problems, by checking movement information, command information, or button image information of each button when a reproduction apparatus selects a button that is designated a selected status, it is possible to stably perform menu navigation so that an improper button is not selected.

While not required, aspects of the invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains. Further, the information storage medium can be an optical medium and/or a magnetic medium.

As described above, according to the present invention, when a reproduction apparatus selects a button from a menu, it is determined whether the button can be designated a selected status using information about the button, and a different button is designated a selected status if the button is an improper button. Accordingly, a user can stably perform menu navigation regardless of conditions. While described in the context of controlling reproduction, it is understood that aspects of the invention can be used to control menus used for recording data and/or transferring data.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method for controlling reproduction of audio/visual data in a reproduction apparatus, the method comprising:
providing at least one input element selectable by a user to execute a predetermined function on a reproduction control screen so that the user controls the reproduction of the audio/visual data; and
when the input element is selected by the reproduction apparatus, determining whether the input element is available according to at least movement information of the input element, and selecting the input element if the input element is available.

2. The method of claim 1, wherein the determination of whether the input element is available is further determined according to command information of the input element, image information of the input element, or combinations thereof.

3. The method of claim 2, wherein the selecting of the input element comprises:
determining whether the movement information of the input element indicates a different input element, whether the command information of the input element exists, and/or whether the image information of the input element exists; and
if it is determined that the movement information of the input element indicates the different input element, that the command information of the input element exists, and/or that the image information of the input element exists, determining that the input element is available.

4. The method of claim 1, wherein the selecting of the input element comprises assigning priorities to at least one piece of information included in the information about the input element, and selecting an input element having a highest priority.

5. The method of claim 1, wherein the selecting of the input element further comprises:
determining whether the input element initially designated in an active page is available according to information about the initially designated input element; and
if it is determined that the initially designated input element is available, selecting the initially designated input element.

6. The method of claim 5, wherein the selecting of the input element comprises:
if it is determined that the initially designated input element is not available, determining whether the different input element is available according to information about the different input element; and
if it is determined that the different input element is available, selecting the different input element.

7. The method of claim 6, wherein the selecting of the input element further comprises, if it is determined that all input elements in the active page are not available, selecting the initially designated input element.

8. The method of claim 1, wherein the input element is selected by the reproduction apparatus, when a status of the reproduction control screen is converted or when a page of the reproduction control screen is converted.

9. The method of claim 1, wherein the reproduction control screen includes a menu, and the input element includes a button included in the menu.

10. An apparatus for controlling reproduction of audio/visual data using a screen, the apparatus comprising:
a reproduction controller providing at least one input element selectable by a user to execute a predetermined function on a reproduction control screen displayed on the screen so that the user controls the reproduction of the audio/visual data,
wherein the reproduction controller comprises a controller determining whether the input element is available according to at least movement information about the input element when the input element is selected by the reproduction apparatus, and selecting the input element if the input element is available.

11. The apparatus of claim 10, wherein the determination of whether the input element is available is further determined according to command information of the input element, and image information of the input element.

12. The apparatus of claim 11, wherein the controller determines at least one of whether the movement information of the input element indicates a different input element, whether the command information of the input element exists, and whether the image information of the input element exists, and
determines that the input element is available, if it is determined that the movement information of the input element indicates the different input element, that the command information of the input element exists, or that the image information of the input element exists.

13. The apparatus of claim 10, wherein the controller assigns priorities to at least one piece of information included in the information about the input element, and selects an input element having a highest priority.

14. The apparatus of claim 10, wherein the controller further determines whether the input element initially designated in an active page is available according to information about the initially designated input element, and selects the initially designated input element if determined that the initially designated input element is available.

15. The apparatus of claim 14, wherein the controller determines whether the different input element in the active page is available according to information about the different input element if it is determined that the initially designated input element is not available, and selects the different input element if it is determined that the different input element is available.

16. The apparatus of claim 15, wherein the controller selects the initially designated input element, if it is determined that all input elements in the active page are not available.

17. The apparatus of claim 10, wherein the input element is selected by the reproduction apparatus, when a status of the reproduction control screen is converted or when a page of the reproduction control screen is converted.

18. The apparatus of claim 10, wherein the reproduction control screen includes a menu, and the input element includes a button included in the menu.

19. A method for selecting an appropriate input element for controlling reproduction of audio/visual data, the method comprising:
determining whether configuration information of a first input element to be selected includes command information and movement information of a second input element; and
if it is determined the that first input element includes the command information and the movement information of the second input element, selecting the second input element.

20. The method of claim 19, wherein if it is determined that the first input element does not include the command information and the movement information of the second input element, determining whether the second input element exists in a current active page.

21. The method of claim 20, wherein if determined that the second input element does not exist in the current active page, selecting the first input element.

22. The method of claim 20, wherein if determined that the second input element exists in the current active page, selecting the second input element.

23. A recording and/or reproducing apparatus for controlling recording and/or reproduction of data using a screen, the apparatus comprising:
a reproduction controller providing at least one selectable input element for executing a predetermined function on a reproduction control screen displayed on the screen for controlling the recording and/or reproduction of the data,
wherein the reproduction controller comprises a controller determining whether the input element is available according to at least movement information about the input element when the input element is selected by the apparatus, and selecting the input element if the input element is available.
